(19) United States
(12) Patent Application Publication
(10) Pub. No.: US 2010/0070564 A1
(43) Pub. Date: Mar. 18, 2010

(54) Method and apparatus for bidirectional multiplexing of information channels

(76) Inventors: Karsten Ehms, Munich (DE); Manfred Langen, Munich (DE)

Correspondence Address: STAAS & HALSEY LLP, SUITE 700, 1201 NEW YORK AVENUE, N.W., WASHINGTON, DC, 20005, US

(21) Appl. No.: 12/314,442

(22) Filed: Dec. 10, 2008

(30) Foreign Application Priority Data
Sep. 12, 2008 (EP) EP08016156

(51) Int. Cl. G06F 15/16; G06N 5/02

(52) U.S. Cl. 709/203; 709/219; 706/46

(57) ABSTRACT

An adaptive content aggregation unit switches content data streams provided by content sources on aggregation channels for client applications of users. An adaptive content distribution unit switches content data streams generated by client applications on distribution channels. Switching of said content data streams is performed by said content aggregation unit and said content distribution unit depending on meta data of user-related profiles and depending on meta data of content-related data stream profiles. The apparatus allows improved information management of data content in a network environment and automatically forms social contacts between users having similar interests.

### CROSS REFERENCE TO RELATED APPLICATIONS

This application is based on and hereby claims priority to European Application No. EP08016156 filed on Sep. 12, 2008, the contents of which are hereby incorporated by reference.

### BACKGROUND

The invention relates to an apparatus and a method for bidirectional multiplexing of information channels of an information management system.

In a conventional system information is transported between dedicated data sources and data-consuming destination devices. Information data is requested explicitly from a data source such as a content provider and then forwarded to the requesting user. A user requests content data such as text data or multi-media data from a content provider by sending a request via a data network to a server of the content provider.

On a computer of a user a client application is executed which can consume the received data content. The received data content is processed by the client computer of the user to provide evaluation results to the user. On the other hand, other applications can be executed which produce or generate content data which the user can publish on specific servers or websites. For example, a user can publish content data generated by him on so-called blog websites. A blog is a website which can provide commentary on particular subjects. A typical blog website combines text, images and links to other blogs, web pages and other media related to its specific topic. Blog websites offer the ability for readers, i.e. users to leave comments in an interactive format. Most blog websites are primarily textual, although other blog websites focus on multi-media such as photographs (photo blog), videos (v-blog) and audio (podcasting). Accordingly, more and more users not only consume data provided by servers but also produce and publish data for other users. For publishing data the users forward the generated content data to content repositories or content destinations. With the increasing number of users participating in a common network such as the internet the number of content sources and content destinations becomes hardly manageable. Further, the client applications executed by computers of users become more and more heterogeneous. This leads often to an unsuccessful search for content data in a heterogeneous network comprising a plurality of different data sources and data destinations.

### SUMMARY

Accordingly, it is one potential object to provide a method and an apparatus for an improved information management of data contents in a network environment.

The inventors propose a bidirectional information channel multiplexer comprising an adaptive content aggregation unit which switches content data streams provided by content sources on aggregation channels for client applications of users, an adaptive content distribution unit which switches content data streams generated by client applications on distribution channels, wherein a switching of the content data streams is performed by the content aggregation unit and the content distribution unit depending on meta data of user-related profiles and depending on meta data of content-related data stream profiles.

In an embodiment of the proposed bidirectional information channel multiplexer the user-related profiles comprise user-defined profiles, user-group-defined profiles and usage-derived profiles.

In an embodiment of the proposed bidirectional information channel multiplexer, the user-related profile is formed by consumer-related profile of a user consuming content data or by a producer-related profile of a user generating content data.

In an embodiment of the proposed bidirectional information channel multiplexer the consumer-related profile comprises content tags indicating preferenced content data of a user, preferenced authors of content data, and content source identifications of preferenced content sources.

In an embodiment of the proposed bidirectional information channel multiplexer, the producer-related profile comprises content tags indicating content data generated by a client application of the user, and content destination identifications of preferenced content destinations.

In an embodiment of the bidirectional information channel multiplexer the usage-derived profile is derived from content data consumed by client applications of a user or derived from content data generated by client applications of a user.

In an embodiment of the bidirectional information channel multiplexer each content data stream comprises a content-related data stream profile and at least one content object.

In an embodiment of the proposed bidirectional information channel multiplexer the content-related data stream profile comprises content tags, content authors, and content source identifications indicating content sources.

In an embodiment of the proposed bidirectional information channel multiplexer a content object comprises content tags, content authors, content source identification indicating a content source of the content object, and content data.

In an embodiment of the proposed bidirectional information channel multiplexer the user-related profiles are stored in a memory of the bidirectional channel multiplexer.

In an embodiment of the proposed bidirectional information channel multiplexer a switching of content data streams is performed directly or after the affected users have agreed to the respective switching.

In an embodiment of the proposed bidirectional information channel multiplexer the bidirectional information channel multiplexer is integrated in a server of a data network.

In an embodiment of the proposed bidirectional information channel multiplexer the information channel multiplexer comprises a calculation unit for performing a matching algorithm which matches the user-related profiles with the content-related data stream profiles.

In an embodiment of the proposed bidirectional information channel multiplexer the channels are logical channels.

In an embodiment of the proposed bidirectional information channel multiplexer the user-defined profile comprises a user-defined contact channel for establishing a contact with other users consuming or generating content data streams with similar data content.

In an embodiment of the proposed bidirectional information channel multiplexer the content data comprises text data and multi-media data.

In an embodiment of the proposed bidirectional information channel multiplexer the content data streams comprise RSS-content data steams and ATOM content data streams.

In an embodiment of the proposed bidirectional information channel multiplexer the user-related profile comprises configurable switching parameters.

The inventors further propose a server of an information management system comprising a bidirectional information channel multiplexer comprising: (a) an adaptive content aggregation unit which switches content data streams provided by content sources on aggregation channels for client applications of users; (b) an adaptive content distribution unit which switches content data streams generated on distribution channels; (c) wherein a switching of the content data streams is performed by the content aggregation unit and the content distribution unit depending on meta data of user-related profiles and depending on meta data of content-related data stream profiles.

The inventors further propose an apparatus performing a bidirectional multiplexing of information channels, wherein the apparatus comprises a switching unit to switch control data streams transported via the channels depending on meta data of user-related profiles and depending on meta data of content-related data stream profiles of the transported content data streams which are generated or consumed by client applications of users.

The inventors further propose a method for performing a bidirectional multiplexing of information channels, wherein a switching of content data streams transported via the channels is performed depending on meta data of user-related profiles and depending on meta-data of content-related data stream profiles of the transported content data streams which are generated or consumed by client applications of users.

In an embodiment of the proposed method the user-related profiles are formed by user-defined profiles which are configured by users and by usage-derived profiles derived from content data consumed or generated by client applications of the users.

In an embodiment of the proposed method the user-related profiles are matched with the content-related data stream profiles by a matching algorithm performed by a bidirectional information channel multiplexer to control switching of the content data streams.

In an embodiment of the proposed method the method is performed by a computer program executed by a bidirectional information channel multiplexer.

In an embodiment of the method according to the present invention the computer program is loaded from a data carrier, which stores the computer program.

The inventors further propose a computer-readable program product for storing a computer program which comprises instructions for performing the proposed method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a block diagram of a possible embodiment of a computer architecture comprising a server with a bidirectional information channel multiplexer according to the present apparatus;

FIG. 2 shows a block diagram of a possible embodiment of a bidirectional information channel multiplexer according to the proposal;

FIGS. 3A, 3B illustrate possible data structures of user-related profiles as employed by the bidirectional information channel multiplexer according to the proposal;

FIG. 4 shows a diagram of a data structure of a content data stream processed by a bidirectional information channel multiplexer according to the proposal.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

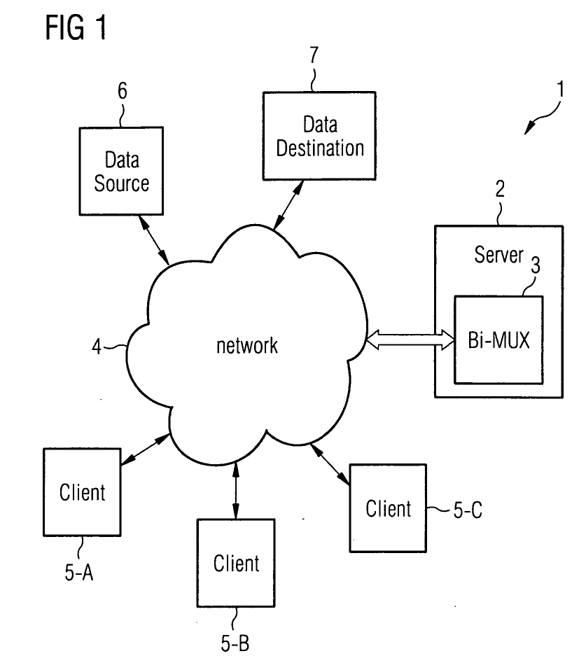

As can be seen from FIG. 1 a computer system 1 comprises at least one server 2 having an integrated bidirectional information channel multiplexer 3 according to the inventors' proposal. The server 2 can be an exchange server connected to a data network 4 being a local area network or a wide area network. In a possible embodiment the network 4 is formed by the internet. In an alternative embodiment the network 4 is formed by an intranet of a company. Several client computers 5-A, 5-B, 5-C are connected to the network 4 as well as data sources 6 and data destinations 7. The data sources 6 and data destinations 7 can also be formed by servers. The data sources 6 can be formed by servers of content providers and the data destination server 7 can be servers of content publishers. The client computers 5 belong to users having individual preferences and running different client application programs. Client applications run by the client computers can be for example web browsers, Really Simple Syndication (RSS) client software applications, blog client applications or feed aggregation applications.

RSS is a family of web feed formats used to publish updated content such as blog entries, news headlines and podcasts in a standardized format. A RSS document is also called a feed or a web feed. A RSS document can contain either a summary of content from an associated website or a full text. The standardized XML file format allows the information to be published once and viewed by many different programs or client applications. The user subscribes to a feed by entering a feed link into the reader or by clicking an RSS icon in a browser that initiates a subscription process. An RSS reader checks the user subscribed feeds regularly for preferenced contents and downloads any updates that it finds. Content providers can publish feed links on their website which end-users can activate with an aggregator program running on their client computer. A content provider can publish a feed link on its website and end-users can register with an aggregator program which is also called a feed reader. Aggregators can then be scheduled to check for updated content periodically. Web feeds have advantages when compared to receiving frequently published content via e-mail. When subscribing to a web feed a user does not have to disclose its e-mail address. Consequently, users are not increasing their exposure to the network environment associated with e-mail such as spam, viruses, phishing and identity theft. Furthermore, if users want to stop receiving particular content they do not have to send an unsubscribe request but can simply remove the web feed from the respective aggregator program. Further, web feed items can be automatically sorted such that each feed URL has its own list of entries. A feed reader can be used either on- or off-line.

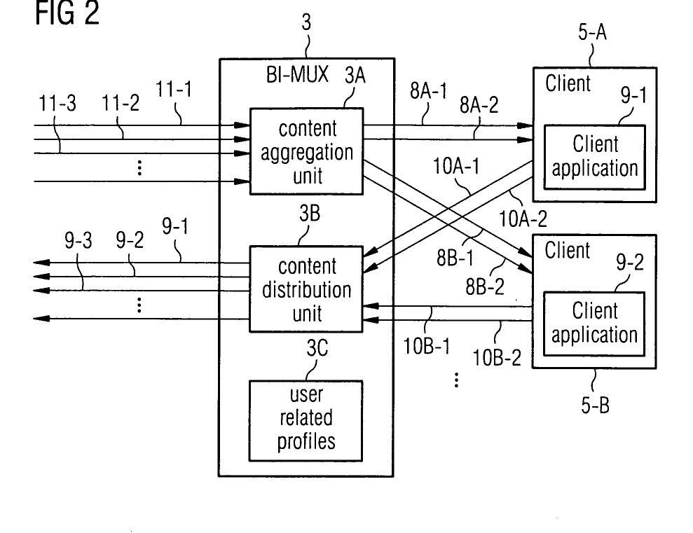

FIG. 2 shows a block diagram of a possible embodiment of a proposed bidirectional information channel multiplexer 3 which can be integrated in a server 2 as shown in FIG. 1. The bidirectional information channel multiplexer 3 comprises a content aggregation unit 3A, a content distribution unit 3B and in a possible embodiment a user-related profile memory 3C. The content aggregation 3A switches content data streams provided by one or several content sources on aggregation channels 8 to client applications 9 executed by client computers 5 of one or several users. Client applications are programs such as web browsers, RSS client programs, blog line programs or feed aggregation programs.

The bidirectional information channel multiplexer 3 further comprises a content distribution unit 3B which switches content data streams generated by client applications on distribution channels 9. The content distribution unit 3B receives the content data streams from the client applications via information channels 10 whereas the content aggregation unit 3A receives the content data streams from data sources via information channels 11 as shown in FIG. 2. The information channels 8, 9, 10, 11 are logical channels of a higher layer within the OSI reference model and not physical channels. The switching of the content data streams is performed by the content aggregation unit 3A and the content distribution unit 3B depending on meta data of user-related profiles and depending on meta data of content-related data stream profiles.

In the embodiment shown in FIG. 2 the meta data of the user-related profiles are stored in a user-related profile URP memory 3C of the bidirectional information channel multiplexer 3.

Every user of a client computer 5 can have a corresponding user-related profile URP within the bidirectional information channel multiplexer 3. The user-related profile URP of a user comprises the user-defined profile and a usage-derived profile.

The user-defined profile can be configured by a user by a configuration software via a configuration channel. The user-defined profile can be a profile of a user which either consumes content data or which generates content data or which both consumes and generates content data.

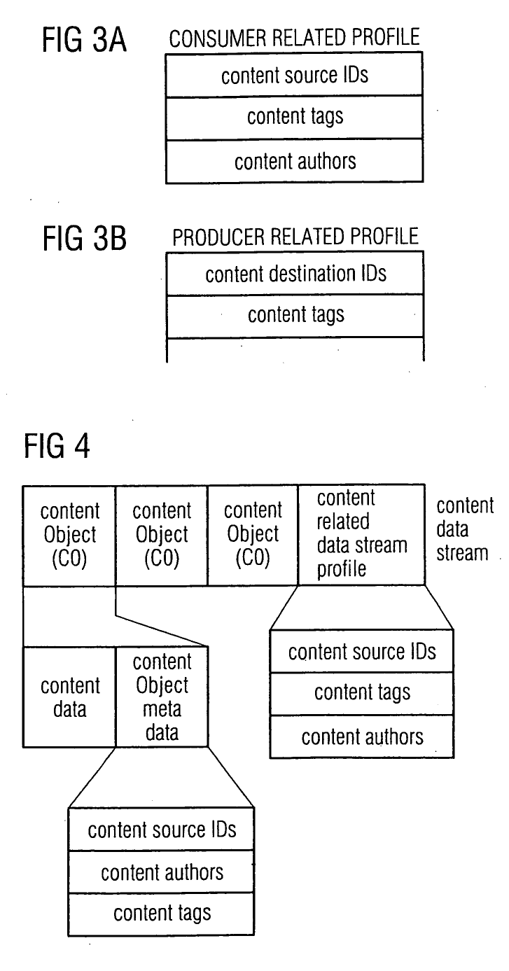

A consumer-related profile of a user which consumes content data is shown in FIG. 3A. The consumer-related profile comprises one or several content source identifications of preferenced content sources 5 such as servers or data bases. In a possible embodiment the content source identifications are formed by content source addresses such as a URL (uniform resource allocator) address. Furthermore, the consumer-related profile shown in FIG. 3 comprises content tags indicating the preferenced content data of the respective user. The content tags are in a preferred embodiment text tags comprising one or several nouns indicating preferenced contents. For example, a user who is interested in nanotechnology might configure its user-related profile by inputting content tags forming key words related to nanotechnology. Furthermore, the consumer-related profile shown in FIG. 3A can comprise content authors indicating preferenced authors of the respective user. For example, a user might wish to receive content data from one or several of his preferenced experts in the respective field of interest.

The user-related URP profile can also comprise a producer-related profile of a user which generates content data of its own. Such a producer-related profile as shown in FIG. 3B comprises one or several content destination identifications of preferenced content destinations. These content destination identifications can be for example destination addresses of data destinations 7 such as servers of content publisher. The producer-related profile further comprises content tags input by the user e.g. by an input device such as a keyboard and specifying the content data produced or generated by the user with the help of a respective client application 9.

The client application 9 executed by client computer 5 of a user can either generate or consume content data. This content data can comprise text data of a document but also multi-media data such as audio or video data. The user-related profiles URP stored in the memory 3C of the bidirectional multiplexer 3 as shown in FIG. 2 can comprise besides the user-defined profiles configured by the respective user also usage-derived profiles.

A usage-derived profile is derived from content data consumed by client application programs 9 of the respective user or from content data generated by a client application 9 of the respective user. In this embodiment the bidirectional information channel multiplexer 6 comprising the content aggregation unit 3A and the content distribution 3B monitors the content data consumed or produced by a client application software 9 of a client computer 5 of a user. In this embodiment the bidirectional information channel multiplexer 3 adapts the usage-derived profile of a user depending on the detected volume of consumed or produced content data in a specific content category.

FIG. 4 shows a possible embodiment of a data structure for a content data stream as employed by the proposed method and apparatus. A content data stream CDS transported via a logical channel comprises one or several content objects CO and a content-related data stream profile CDSP. This content-related data stream profile CDSP comprises in a possible embodiment content source identifications indicating data sources 6 from which one or several of the content objects CO are supplied. This content source identifications can be formed in a possible embodiment by addresses such as uniform resource allocators (URLS) or IP-addresses of servers. The content-related data stream profile CDSP of a content data stream CDS comprises furthermore content tags indicating content included in one or several of the content objects CO of the respective content data stream CDS. Furthermore, the content-related data stream profile CDSP can comprise content authors of content data included in one or several of the content objects CO. Each content object CO of a content data stream CDS comprises content data such as text data or multi-media data and content object meta data. The content object meta data of a content object CO comprises a content source identification such as an address of a data source from which this content object CO is originated. Content object meta data further comprises content authors which have generated the content data of the respective content object CO. The content object meta data furthermore includes content tags indicating the content of the respective content data. The content data stream CDS shown in FIG. 4 is only an exemplary embodiment. Content data streams CDS can have different data structures. A content data stream CDS can be forwarded as a continuous data stream or by data packets according to different data transportation protocols.

In a possible embodiment a user-related profile URP can be transported as a content data stream CDS via a communication channel from a client computer 5 to the bidirectional information channel multiplexer 3 as shown in FIG. 2. This allows a remote configuration of the user-related profile URP stored in memory 3C.

In a possible embodiment the bidirectional information channel multiplexer 3 performs the switching of content data streams CDS depending on the meta data of the user-related profiles URP and depending on the meta data of the content-related data stream profiles CDSP directly without acknowledgement of the affected users. In a preferred embodiment the switching of the content data streams CDS is performed by the bidirectional information channel multiplexer 3 after the affected users have agreed to a channel switching proposed by the bidirectional information channel multiplexer 3. In this embodiment the multiplexer 3 informs the user of a possible information channel which might be of interest to the user and which the bidirectional information channel multiplexer 3 proposes to switch to the client computer 5 of the user. The user can then decide whether to accept the proposed switching or not. In case that the user accepts the proposed switching of the information channel the bidirectional information channel multiplexer 3 performs the acknowledged channel switching.

In a possible embodiment of the content aggregation unit 3A and the content distribution unit 3B have a calculation unit such a microprocessor performing a matching algorithm which matches the user-related profiles URP stored in the memory 3C with the content-related data stream profiles CDSP of content data profiles as shown in FIG. 4.

In a possible embodiment a user-defined profile URP as stored in the memory 3C can comprise a user-defined contact channel for establishing a contact with other users consuming or generating content data streams CDS with similar data content. In this embodiment the bidirectional multiplexer 6 can propose contacts to a user for social networking with other users having the same interests. In this embodiment if the bidirectional information channel multiplexer 3 detects that two or more users generate or consume content data in a similar field of interest such as nanotechnology it can send a request for establishing a contact to the contact channels of the respective users as defined in the user-related profiles URP of these users stored in the memory 3C.

In a possible embodiment the user can define his e-mail address as a contact channel. Furthermore, the user can define whether the e-mail address stored in the user-related profile URP as a contact channel can be forwarded to other users having matching interests. In this way users can build up user groups producing or consuming data content in the same or similar fields. Such a user group can be formed for example within a company by a server 2 connected to the intranet of the company monitoring the content flow of different experts. In this way employees of a company working in the same technical field can be brought together to the benefit of the company.

In a further embodiment a supervisor or an administrator can define user groups and user group related profiles UGRP thus establishing that users of this group receive content data streams CDS as specified in a user group related profile UGRP. In this case the user-related profiles of the user group are not configured by the user himself but by a third person such as a system administrator or a responsible user group manager.

In the embodiment shown in FIG. 2 the user-related profiles URP are stored in a memory 3C of the bidirectional information channel multiplexer 3. In an alternative embodiment the user-related profile URP is transported by a content data stream CDS.

In a further alternative embodiment the user-related profile URP is read from a data carrier inserted into a reading device of the bidirectional information channel multiplexer 3.

In a further possible embodiment the bidirectional information channel multiplexer 3 comprises a configuration interface for configuration of user-defined profiles.

In a possible embodiment the user-related profiles URP comprise configurable switching parameters. These configurable switching parameters can be for example weighting factors or threshold values. For example a user can define that if a data source supplies content data streams CDS with a specific configurable content frequently, i.e. more than a predetermined number of times within a specific time period, this information channel has to be switched to the client computer 5 of the interested user.

In a possible embodiment the content data streams CDS as shown in FIG. 4 can be formed by RSS content data streams. In an alternative embodiment the content data streams CDS are formed by ATOM content data streams.

In a possible embodiment the software application program 9 comprises a flexible RSS interface to provide content data seamless to content destinations such as content publishing servers. The client application 9 further operates with permanent valid links as source identifications to allow content referencing to other kind of applications. The client applications 9 can allow a tagging of contents. The user-related profiles URP and the content-related data stream profiles can be either explicitly configured or dynamically adapted, i.e. they can be implicitly adapted. For example by reading text documents of specific authors, i.e. preferenced authors, a user-related profile URP can be adapted to these preferenced authors. By reading text documents comprising preferenced tags a user-related profile URP can be adapted automatically and dynamically to such preferenced contents.

In a possible embodiment a user can configure weighting factors for weighting different information data within its user defined profile. For example a user can configure or set weighting factors for content source IDs, content tags, content authors or content destination IDs.

There is a plurality of use cases for the application and use of the proposed method and apparatus. For example a userA having a client computer 5A as shown in FIG. 2 can configure its user-related, content source, such as “ticky news” by adding a content source ID or an address of the referenced server. Furthermore, the userA can input content tags such as “technology” and “innovation” to receive content data concerning new technologies. According to its user-related profile user A receives often articles as content objects CO within a content data stream CDS with a tag “nanotechnology” via a channel 11. Since the bidirectional information channel multiplexer 3 is aware of another channel 11′ from another data source or web server “nano news” having the content profile “nanotechnology” which is used by another user B a switching of the other channel 11′ to the first user A is performed directly or after a corresponding proposal and acknowledgement if the first user A reads articles concerned with nanotechnology frequently and the number of read articles surpasses a predefined threshold value which can be configured as a switching parameter by the first user A. Accordingly, the first user A receives then content data both via the original channel 11 and via the other channel 11′ from both data sources, i.e. “ticky news” and “nano news”.

In a possible embodiment the bidirectional multiplexer 3 can furthermore establish automatically a contact between both users A, B by the contact channels designated in the user related profiles URP of both users. For example the bidirectional multiplexer 3 can send both users A, B which are interested in “nanotechnology” the contact address of the other user respectively.

In a possible embodiment users receive with the proposed contact also information about the content data which the other user has consumed or published to help the decision of a user whether he shall establish a direct personal or social contact with the other user. For example when a user recognizes that another user has already published a high volume of content data related to the specific topic of interest he will be inclined to contact this expert.

In another use case on the distribution side a first user A publishes often content data with the tag “innovation” via an information data channel on a publishing Server X. Since the bidirectional multiplexer 3 is aware of another publishing server Y having the content profile “innovation” which is used by a second user B as a destination or publishing server it can switch content published by the first user A to the publishing server Y to publish the content produced by the first user A also on this server Y.

With the bidirectional information channel multiplexer 3 contacts between consuming and publishing users can be established. The proposed method and apparatus allow a dynamic connection of content platforms as data sources and data destinations with user-related contents. These user-related contents can be either consumed or produced by the respective users. Personal or collective user related profiles URP are generated dynamically and adapted explicitly or implicitly. In this way a user can concentrate on his work and has not to waste much time looking for data sources where he can get the necessary information or for data destinations where he can publish content generated by himself. Furthermore, the bidirectional information channel multiplexer 3 is very helpful in forming automatically a social network with other users having the same or similar interests. The bidirectional information channel multiplexer 3 can be integrated in a server 2 of a data network such an intranet or in a wide area network such as the internet.

In a possible configuration, the bidirectional information channel multiplexer 3 can form part of an information management system. The bidirectional information channel multiplexer 3 is specifically suited for a semantic web. The semantic web is an extension of the world wide web in which semantics of information and services are defined. Within a semantic web descriptive technologies such as a resource description framework RDF and web ontology language (OWL) as well as extensible mark up language XML are employed. Machine-readable content descriptions enable content managers to add meaning to the content, i.e. describe the structure and the knowledge about the respective content.

The embodiments can be implemented in computing hardware (computing apparatus) and/or software, such as (in a non-limiting example) any computer that can store, retrieve, process and/or output data and/or communicate with other computers. The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV 69 USPQ2d 1865 (Fed. Cir. 2004).

What is claimed is:

1. A bidirectional information channel multiplexer comprising:
an adaptive content aggregation unit which switches content data streams provided by content sources, to aggregation channels for client computers of respective users, each user having a user-related profile represented with meta data; and
an adaptive content distribution unit which switches content data streams generated by client computers, to distribution channels, wherein
each content data stream has a content-related profile represented with meta data,
the content aggregation unit and the content distribution unit switch content data based on the meta data of the user-related profiles and based on the meta data of the content-related profiles, and
each user controls, through the bidirectional information channel multiplexer, content data flowing to and from the respective client computer such that the user's e-mail address is not provided to any of the content sources and the user's e-mail address is not provided to any of the distribution channels.

2. A bidirectional information channel multiplexer comprising:
an adaptive content aggregation unit which switches content data streams provided by content sources, to aggregation channels for client applications of users, each user having a user-related profile represented by meta data; and
an adaptive content distribution unit which switches content data streams generated by client applications, to distribution channels, wherein
each content data stream has a content-related profile represented with meta data, and
the content aggregation unit and the content distribution unit switch content data based on the meta data of the user-related profiles and based on the meta data of the content-related profiles.

3. The bidirectional information channel multiplexer according to claim 2,
wherein said user-related profiles are selected from the group consisting of user-defined profiles, user-group-defined profiles and usage-derived profiles.

4. The bidirectional information channel multiplexer according to claim 2,
wherein said user-related profiles are formed by consumer-related profiles of users consuming content data or by producer-related profiles of users generating content data.

5. The bidirectional information channel multiplexer according to claim 4, wherein each consumer-related profile is selected from the group consisting of a content tag indicating preferred content data of the respective user, an author preferred by the respective user, and a content source identification of a preferred content source.

6. The bidirectional information channel multiplexer according to claim 4, wherein each producer-related profile is selected from the group consisting of a content tag generated by a client application of the respective user, and a content destination identification of a preferred content destination.

7. The bidirectional information channel multiplexer according to claim 3, wherein each usage-derived profile is derived from content data consumed by a client application of a user or is derived from content data generated by a client application of the user.

8. The bidirectional information channel multiplexer according to claim 2, wherein each content data stream comprises a content-related data stream profile and at least one content object.

9. The bidirectional information channel multiplexer according to claim 8, wherein each content-related data stream profile is selected from the group consisting of a content tag indicating content data of a content object within the content data stream, a content author, and a content source identification indicating a content source.

10. The bidirectional information channel multiplexer according to claim 8, wherein each content object is selected from the group consisting of a content tag, a content author, a content source identification indicating a content source of a content object, and content data.

11. The bidirectional information channel multiplexer according to claim 2, wherein said user-related profiles are stored in a memory of said bidirectional information channel multiplexer.

12. The bidirectional information channel multiplexer according to claim 2, wherein said switching of content data streams is performed after the affected users have agreed to the respective switching.

13. The bidirectional information channel multiplexer according to claim 2, wherein said bidirectional information channel multiplexer is integrated in a server of a data network.

14. The bidirectional information channel multiplexer according to claim 2, wherein said bidirectional information channel multiplexer comprises a calculation unit for performing a matching algorithm which matches said user-related profiles with said content-related data stream profiles.

15. The bidirectional information channel multiplexer according to claim 2, wherein said distribution channels are logical channels.

16. The bidirectional information channel multiplexer according to claim 3, wherein at least one of the user-defined profiles comprises:
a user-defined contact channel for establishing a contact with another user consuming or generating a content data stream with similar data content.

17. The bidirectional information channel multiplexer according to claim 2, wherein said content data comprises text data and multi-media data.

18. The bidirectional information channel multiplexer according to claim 2, wherein said content data streams comprise RSS content data steams and ATOM content data streams.

19. The bidirectional information channel multiplexer according to claim 2, wherein each user-related profile comprises a configurable switching parameter.

20. A server for an information management system, comprising:
a file server unit; and
a bidirectional information channel multiplexer comprising:
an adaptive content aggregation unit which switches content data streams provided by content sources, to aggregation channels for client applications of users, each user having a user-related profile represented by meta data; and
an adaptive content distribution unit which switches content data streams generated by client applications, to distribution channels, wherein
each content data stream has a content-related profile represented with meta data, and
the content aggregation unit and the content distribution unit switch content data based on the meta data of the user-related profiles and based on the meta data of the content-related profiles.

21. An apparatus for bidirectional multiplexing of information channels, comprising:
means for switching content data streams transported via respective channels, the content data streams being switched based on meta data of user-related profiles and based on meta-data of content-related profiles of the content data streams, the content data streams being generated or consumed by client applications of users.

22. A method for performing a bidirectional multiplexing of information channels, comprising:
switching content data streams transported via respective channels, the content data streams being switched based on meta data of user-related profiles and based on meta-data of content-related profiles of the content data streams, the content data streams containing content data generated or consumed by client applications of users.

23. The method according to claim 22,
wherein said user-related profiles are formed by user-defined profiles configured by users and by usage-derived profiles derived from the content data generated or consumed by client applications of said users.

24. The method according to claim 22,
wherein the user-related profiles are matched with the content-related profiles by a matching algorithm performed by a bidirectional information channel multiplexer to control switching of said content data streams.

25. The method according to claim 22,
wherein the method is performed by a computer program executed by a bidirectional information channel multiplexer.

26. The method according to claim 25, wherein the computer program is loaded from a data carrier, which stores said computer program.
